(19) United States
(12) Patent Application Publication
(10) Pub. No.: US 2012/0176579 A1
(43) Pub. Date: Jul. 12, 2012

(54) Eyeglasses with built in enclosure

(76) Inventor: Kewin Alford, Biloxi, MS (US)

(21) Appl. No.: 12/930,406

(22) Filed: Jan. 7, 2011

(51) Int. Cl. G02C 5/14

(52) U.S. Cl. 351/116

(57) ABSTRACT

Eyeglasses whose temple bars each have a U shaped cross section. The temple bars are each held in place by a magnetic catch. When the temple bars are folded, the frame member of the eyeglasses can reside within the hollow area formed by hollow space created by the two U shaped cross sectional temple bars. One temple bar encloses the top half of the frame. The second temple bar encloses the bottom half of the frame. A preferred embodiment includes the temple bars each have a cut out portion corresponding to the location of the wearers ears so that the temple bar can rest comfortably on the wearer's ear. A preferred embodiment includes to portion of the cut out portion that interacts with the wearer's ear includes an overlay of resilient material located where the ear and the temple bar interact.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of eyeglasses and more specifically to eyeglasses with a built in enclosure feature. Eyeglasses of various types are well known. They are typically comprised of a frame member that supports a pair of lenses and a pair of temple bars. The left temple bars is hingedly attached to the left side of the frame and the right temple bar is hingedly attached to the right side of the frame. The uses for eyeglasses include the use of corrective lenses for people who have less than perfect vision, as well as sun glasses for eye protection from the rays of the sun, and also safety glasses worn by people who are in close proximity to flying debris.

Typically, when a pair of eyeglasses is folded in the stored position, the temple bars reside behind the frame. Because the temple bars are folded behind the frame, the lens portion of the glasses remains exposed and can become scratched unless they are covered by an eyeglass case or sleeve of some sort. The deficiency of the prior art is that a separate case or sleeve is needed to protect folded eyeglasses. A separate case is problematic in that it can be lost or forgotten thereby increasing the chance of the lenses of the folded eyeglasses to become scratched or dirty.

### BRIEF SUMMARY OF THE INVENTION

The primary object of the invention is to provide an eyeglass design that has a protective eyeglass enclosure feature built into the temple bars of the eyeglasses.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed eyeglasses with built in enclosure comprising: a pair of lenses, a lens frame, a pair of temple bars, a magnetic catch members, said lenses attached to said lens frame in a standard way, said magnetic catch members each comprised of an elongate square cross section rod member terminating at each end of said lens frame, each said temple bar having a U shaped cross section, each said temple bar terminating at one end in a magnet receiving socket, and said temple bars, when seen from a top view, shaped to conform to the shape of said lens frame when seen from the top view so that when said temple bars are folded, said temple frame and said lenses reside within the confines of said U shaped cross section of said temple bars, one said temple bar enclosing the top half of said frame member and the second said temple bar enclosing the bottom half of said frame member.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a eyeglasses of the present invention.

FIG. 2 is an exploded view of the eyeglasses of the present invention.

FIG. 3 is a front perspective view of the eye glass frame enclosed within the temple bars.

FIG. 4 is rear perspective view of the eyeglass frame enclosed within the temple bars.

FIG. 5 is a plan view of a temple bar with the eyeglass frame resting within it.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

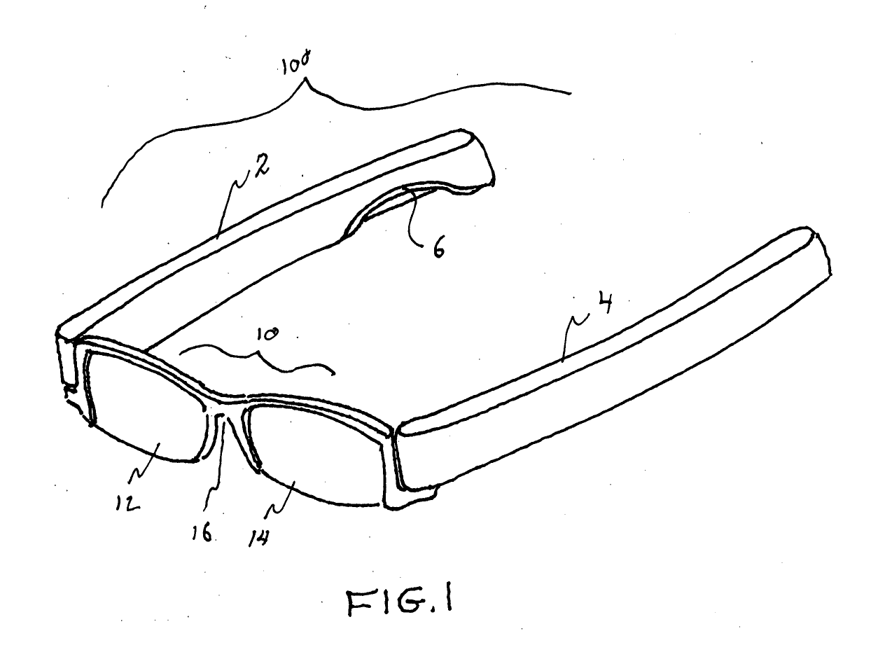

Referring to FIG. 1 we see a perspective view of the present invention 100. An eyeglass frame 10 indudes two standard eyeglass lenses 12, 14. A left 2 and right 4 temple bar are attached to the frame so that the eyeglasses of the present invention 100 can reside on a person's head in the standard way with the nose bridge 16 of the lens frame 10 capable of resting on bridge of the user's nose, and the ends of the temple bars 2, 4, resting on the users ears. An overmolded rubber-like material 6, 7 acts to cushion the area where the user's ear rests.

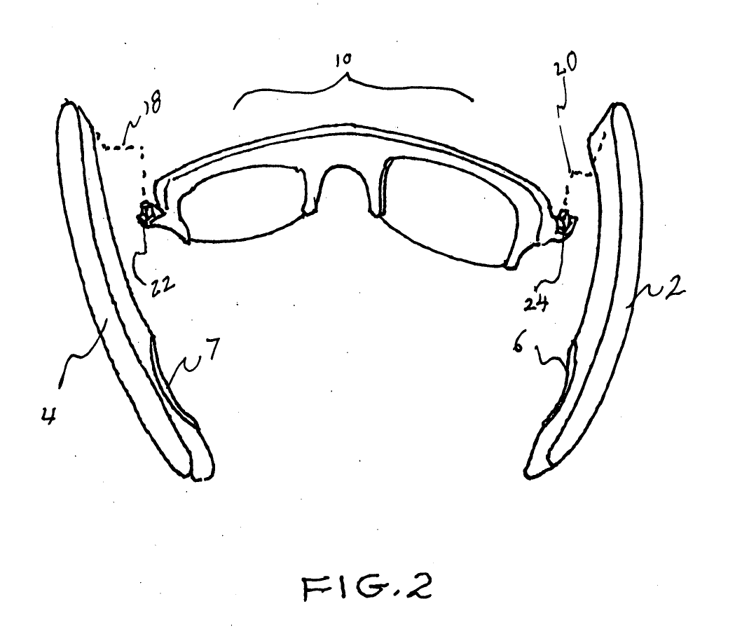

If FIG. 2 we see an exploded view of the invention 100 where the temple bars 2, 4 are removed from the lens frame 10. At each end of the lens frame 10 there resides a square cross section magnet 22, 24. When the magnets 22, 24 engage the inside of each temple bar 2, 4 they are drawn to steel plates 23, within each temple bar socket 30, as shown in partial section view in FIG. 7, so that the temple bars are magnetically attached to the eyeglass frame 10 as shown in a partial section view in FIG. 7. The retaining socket 30 inside each temple bar 2, 4 is square in shape so that when the square magnetic rods 22, 24 are inserted into the square sockets 30 the temple bars 2, 4 are prevented from splaying inward or outward.

The temple bars 2, 4 are U shaped in cross section as shown in FIG. 7 where the two temple bars 2, 4 are placed on top of each other to form a housing that encloses the temple frame 10. In this way, the temple bars 2, 4 perform two functions. One function to act in a standard way to hold the glasses to a person's ears, and the other in a novel way, to act as an enclosure to protect the glass frame 10 and lenses 12, 14 when not being worn by the user.

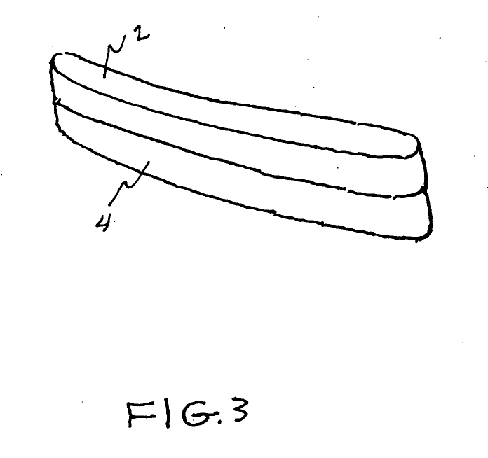

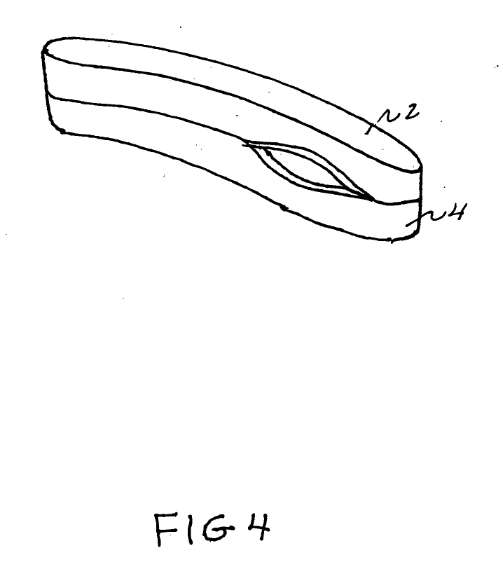

FIG. 3 shows a front perspective view of the temple bars 2, 4 as they enclose the eyeglass frame 10. FIG. 4 shows a rear perspective view of the temple bars 2, 4 as they enclose the eyeglass frame 10.

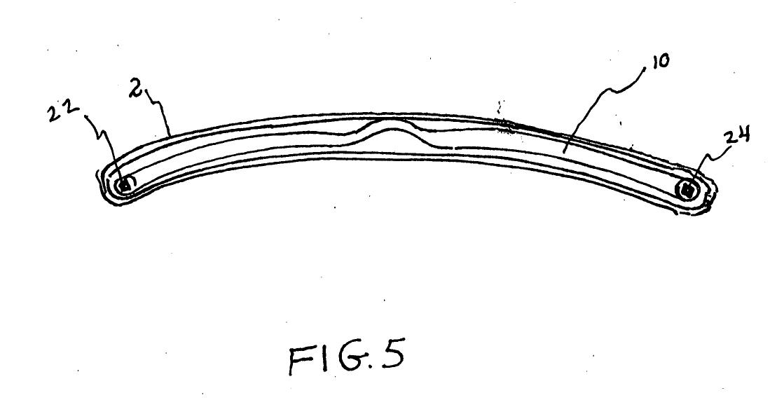

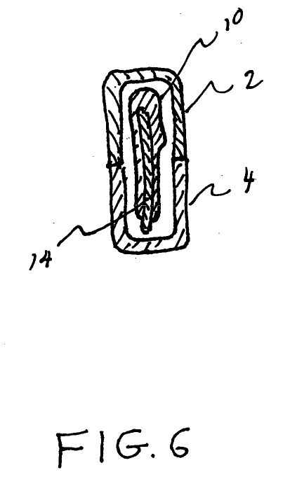

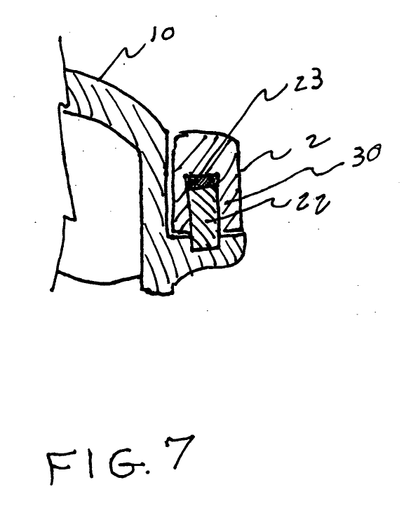

FIG. 5 shows a top plan view looking down into the cavity of one of the temple bars 2 with the eyeglass frame 10 resting in place. The square cross section magnets can be seen on each end of the eyeglass frame 10.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Eyeglasses with built in enclosure comprising:
a pair of lenses;
a lens frame;
a pair of temple bars;
a pair of magnetic catches said lenses attached to said lens frame in a standard way;
said magnetic catch members each comprised of a square cross section rod member fixedly attached in a vertical fashion to each end of said lens frame;
each said temple bar having a U shaped cross section;
each said temple bar terminating at one end in a magnet receiving socket and
said temple bars, when seen from a top view, shaped to conform to the shape of said lens frame when seen from the top view so that when said temple bars are folded, said temple frame and said lenses reside within the confines of said U shaped cross section of said temple bars, one said temple bar enclosing the top half of said frame member and the second said temple bar enclosing the bottom half of said frame member.

2. Eyeglasses with built in enclosure as claimed in claim 1 wherein said temple bars each have a cut out portion corresponding to the location of the wearer's ears so that said temple bar can rest comfortably on said wearer's ear.

3. Eyeglasses with built in enclosure as claimed in claim 2 wherein to portion of said cut out portion that interacts with said wearer's ear includes an overlay of resilient material located where the said ear and the said temple bar interact.
